(19) United States
(12) Patent Application Publication
(10) Pub. No.: US 2023/0011712 A1
(43) Pub. Date: Jan. 12, 2023

(54) CONTROLLING OPTICS IN AN ENCLOSURE USING MAGNETIC ACTUATION

(71) Applicant: NLIGHT, INC., Camas, WA (US)

(72) Inventors: Kenneth V. ALMONTE, Portland, OR (US); Aaron Brown, Vancouver, WA (US)

(73) Assignee: NLIGHT, INC., Camas, WA (US)

(21) Appl. No.: 17/842,097

(22) Filed: Jun. 16, 2022

Related U.S. Application Data
(60) Provisional application No. 63/218,747, filed on Jul. 6, 2021.

(51) Int. Cl. H01S 3/00; G02B 7/182

(52) U.S. Cl. CPC H01S 3/0071; G02B 7/182

(57) ABSTRACT

A magnetically-actuated laser beam control assembly may include a magnetically permeable cover arranged to sealingly couple to an optics housing to cover an opening of the optics housing, an interior sub-assembly, and an exterior sub-assembly. The interior sub-assembly may include includes a linkage having a first section and a second section; the first section of the linkage to receive an optical component; and a ferroelectric or ferromagnetic material on the second section of the linkage. The exterior sub-assembly may include an electromagnet energizable to impart a magnetic force to the ferroelectric or ferromagnetic material to move the optical component from one of a resting position and a different position to the other of the resting position and the different position to cause the optical component to selectively optically process a laser beam. Other embodiments may be disclosed and/or claimed.

### RELATED APPLICATIONS

This application is a non-provisional of and claims priority benefit to U.S. Provisional Application Ser. No. 63/218,747, filed on Jul. 6, 2021, which is incorporated by reference herein in its entirety.

### TECHNICAL FIELD

The present disclosure relates to the field of lasers, and more particularly to systems including an optical fiber to receive a signal from a laser source.

### BACKGROUND

Fiber lasers are widely used in industrial processes (e.g., cutting, welding, cladding, heat treatment, etc.) In some fiber lasers, the optical gain medium includes one or more active optical fibers with cores doped with rare-earth element(s). The rare-earth element(s) may be optically excited (“pumped”) with light from one or more semiconductor laser sources. There is great demand for high power and high efficiency diode lasers, the former for power scaling and price reduction (measured in $/Watt) and the latter for reduced energy consumption and extended lifetime.

### BRIEF DRAWINGS DESCRIPTION

The accompanying drawings, wherein like reference numerals represent like elements, are incorporated in and constitute a part of this specification and, together with the description, explain the advantages and principles of the presently disclosed technology.

FIG. 1 illustrates a schematic diagram of a magnetically-actuated laser beam control assembly coupled to an optic housing, according to various embodiments.

FIG. 2A-B illustrate a schematic diagram of another magnetically-actuated laser beam control assembly coupled to an optic housing, according to various embodiments.

FIG. 3 illustrates a schematic of a magnetically-actuated laser beam control assembly with position feedback, according to various embodiments.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items. The systems, apparatus, and methods described herein should not be construed as limiting in any way. Instead, the present disclosure is directed toward all novel and non-obvious features and aspects of the various disclosed embodiments, alone and in various combinations and sub-combinations with one another. The term “or” refers to “and/or,” not “exclusive or” (unless specifically indicated).

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation. Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus.

Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation.

Laser beam control devices, such as beam switches, may use one or more moving optical components to deflect an incoming beam of light to one or more output ports. To maintain reliability, the optical component(s) are located in a clean, sealed enclosure to avoid contamination. An actuation assembly, to drive the movement of the optical component(s) may include one or more components that, for a number of reasons, may be located outside the clean, sealed enclosure. For example, an actuation assembly may include a motor (e.g., stepper, servo), which may require accessibility for service and/or may be a contaminant source (e.g., due to grease applied to parts of the motor, or outgassing of plastic materials, or the like), and as such may be located outside the clean, sealed enclosure.

A shaft coupled to the motor may pass through a hole in the clean, sealed enclosure. While it may be possible to effectively use a gasket or other seal to seal other holes in the clean, sealed enclosure, the use of a gasket or other seal around the shaft to prevent contaminants from entering the clean, sealed enclosure via the hole can be a point of failure of the system. This is because rotation of the shaft may directly or indirectly control a position of the optical component(s), and as such, the gasket/seal may frequently move relative to the shaft or the enclosure, causing wear of the gasket/seal. The worn gasket/seal may result in the introduction of contaminants into the clean, sealed enclosure (or could impact the rotation of the shaft).

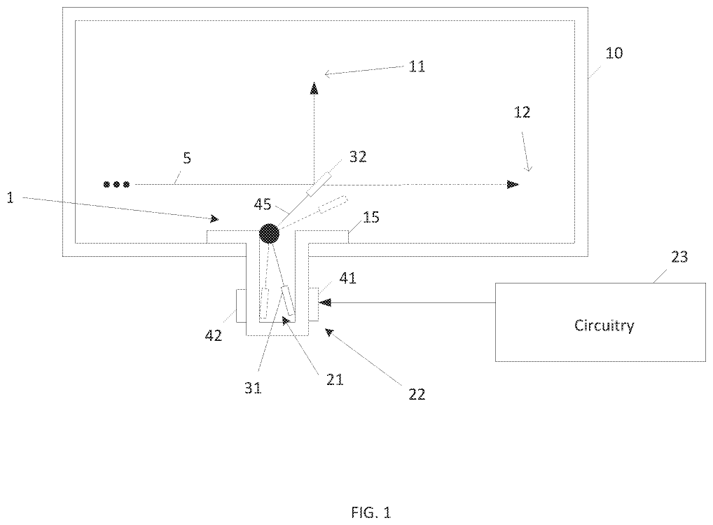

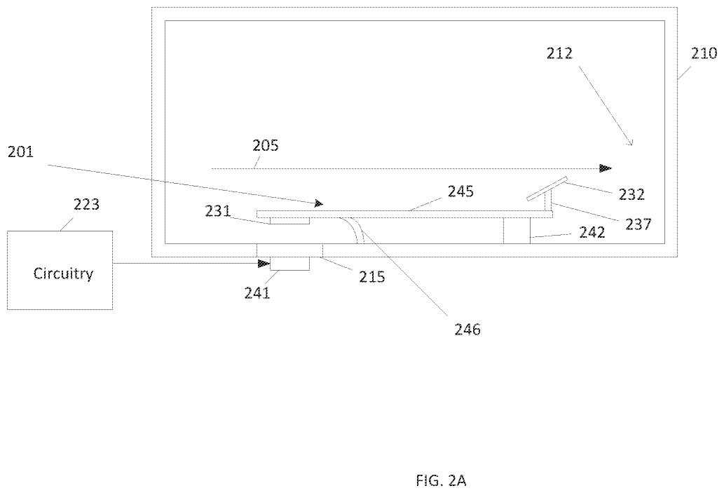

FIG. 1 illustrates a schematic diagram of a magnetically-actuated laser beam control assembly 1 coupled to an optic housing 10 (e.g., an optics enclosure), according to various embodiments. The assembly 1 may include a magnetically permeable cover 15 to cover an opening defined by the optic housing 10 to provide an environmentally isolated optics cavity (e.g., a closed system or some other system that may be isolated from threshold contaminants). The assembly 1 may include a first sub-assembly 21 locatable inside the environmentally isolated optics cavity (i.e. the interior sub-assembly), and a second sub-assembly 22 locatable outside the environmentally isolated optics cavity (i.e. the exterior sub-assembly). The exterior sub-assembly 22 may magnetically actuate the interior sub-assembly 21 to move an optical component 32 from one of a resting position (one of the solid and dashed line positions) and a different position (the other of the solid and dashed line positions).

The exterior subassembly 22 may include an electromagnet 41 (e.g., an electromagnetic coil) and circuitry 23. The circuitry 23 may be configured to selectively provide electrical current to the electromagnet 41 to energize it (or not) to move the optical component 32 to a desired portion based on an input selection. The input selection may be generated by a person or a system coupled to the circuitry 23 to control operation of a fiber laser on a workpiece (or to perform beam monitoring (or the like) in other embodiments. In various embodiments, the circuitry 23 may provide a threshold current to move the optical component into a first position of a pair of positions and no current (or a different current) to move the optical component into a second position of the pair of positions.

The interior subassembly 21 may include a linkage 45, which may be pivotally coupled to the cover 15 as illustrated. The linkage 45 may include a first section on which the optical component 32 is located, and a second section on which a ferroelectric or ferromagnetic material 31 is located. In this embodiment, the ferroelectric or ferromagnetic material 31 may interact with (e.g., be magnetically attracted to) the electromagnet 41 (when the electromagnet 41 is energized by the threshold current). In embodiments in which the ferroelectric or ferromagnetic material 31 is a permanent magnet, electromagnet 41 may interact (e.g., attract or repel—depending on circuit polarity). The linkage 45 may actuate bi-stably, so that the linkage 45 enters one of a pair of positions when the electromagnet 41 is energized by the threshold current and the other of the pair of positions when the electromagnet 41 is not energized by the threshold current (e.g., the circuitry 23 stops providing the current).

The cover 15 may be formed from a non-outgassing plastic—for example, but not limited to Teflon, PEEK (polyether ether ketone), or some other clean polymeric material through which magnetism may be transmitted. The housing 10 may be formed from the same material, or from a different material, such as a metal.

In this embodiment, the cover 15 may include flanges to sealingly couple to an interior surface of the housing 10, as illustrated. In other examples in which the cover 15 includes flanges, the flanges may couple to an exterior surface of the housing 10. In other embodiments, the cover 15 may have any attachment mechanism to sealingly couple to the housing 10 (flanges are not required).

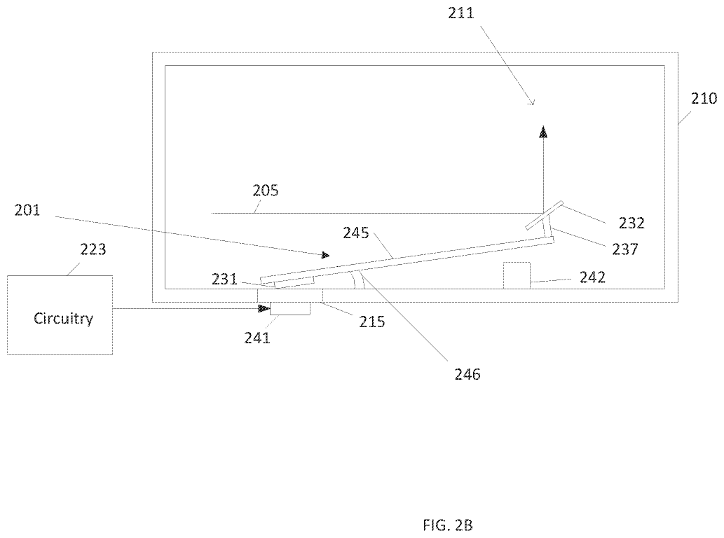

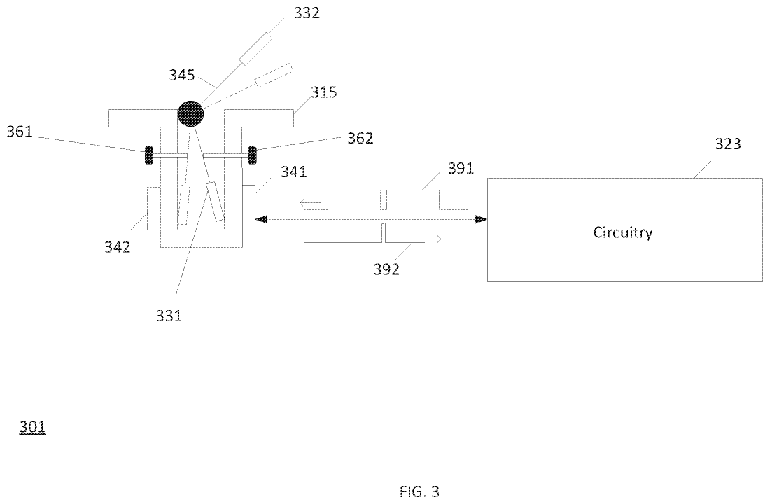

In this embodiment, the cover 15 has a part projecting from the housing 10. An interior of the projection defines an aperture that contains the second section of the linkage 45. This aperture may be referred to as a magnetic aperture, since the magnetic field is transmitted through a sidewall of the aperture. Adjustable or non-adjustable stopping devices (not shown) may be coupled to or integrated with an interior of the magnetic sidewall to limit the range of travel of the linkage 45 (one example of adjustable stopping devices 361 and 362 is shown in FIG. 3). A magnetic aperture is not required in other embodiments, such as the embodiment illustrated in FIGS. 2A-B, which does not feature the magnetic aperture. Various embodiments may include a magnetically permeable planar or non-planar cover.

Referring again to FIG. 1, in some embodiments, it may be possible and practical to utilize the force of gravity to cause the linkage 45 to move into one of these positions when the electromagnet is de-energized. However, this may require a specific orientation of the optical housing 10 relative to the ground, so in various embodiments it may be advantageous to provide a permanent magnet 42 to cause the linkage 45 to move into one of these positions when the electromagnet is de-energized. The permanent magnet 42 may be selected to have a weaker magnetic force than the energized electromagnet 41 so that the linkage 45 leaves the “parking” position when both magnetic forces are applied to the ferroelectric or ferromagnetic material 31 (e.g., to temporarily overcome the static force applied by the permanent magnet 42 or other urging mechanism to “flip” the position of the linkage 45). In embodiments in which the ferroelectric or ferromagnetic material 31 is a permanent magnet, permanent magnet 42 may be omitted because circuit polarity of the current to the electromagnet 31 may be used to selectively attract (or repel) the permanent magnet of the ferroelectric or ferromagnetic material. Other mechanisms for urging the linkage 45 into the parking position such as springs, flexures, and the like, or combinations thereof, for “parking” the linkage 45 may be possible and practical. These other parking mechanisms may be part of the interior subassembly 21 (such a spring coupled to, or integrated with, the linkage 45), the exterior subassembly, or both, according to various embodiments.

The optical component 32 may be a reflector (to guide the laser beam 5 using reflection) or a refractive component (such as a prism or other refractive optical component to guide the laser beam 5 using refraction), or the like, or combinations thereof. In some embodiments, the optical component 32 may be partially-reflective to, when located along the optical path, reflect a portion of the laser beam 5 (e.g., a first wavelength range) and pass a different portion of the laser beam 5 (e.g., a second wavelength range).

The laser beam 5 may originate from a laser source of a laser system, and may be guided to one or more destinations, such as a work piece, beam monitoring device, or the like, or combinations thereof. In some embodiments, the illustrated system may be used as a beam switch to control which destination(s) receive the laser beam 5. For example, in the solid line position, the optical component 32 is located along an optical path of the laser beam 5 for optically processing the laser beam 5, which may guide the laser beam 5 to a first destination associated with first location 11. In the dashed line position, the optical component 32 is not located along the optical path of the laser beam 5, which may guide the laser beam 5 to a second different destination associated with a second location 12. Also, in other embodiments, the optical component 32 may be a beam splitter (so that the laser beam 5 is guided to both destinations associated with locations 11 and 12 in the solid line position).

The illustrated system can be used for any applications (e.g., is not limited to the beam switching and/or laser system embodiments described herein). The optical housing 10 may enclose some or all of the individual optical components of a free-space optics of an optic system (e.g., a laser system) to protect the enclosed individual components from contaminants. The optic system may include other components that may be located outside the optical housing 10. For example, the origination source of the laser beam (e.g., the laser source) and other components (e.g., process heads, beam monitoring devices, or the like, or combinations thereof) may each be located outside the optical housing 10. The laser beam 5 may ingress and egress the optical housing 10 via ingress optical fibers or input/output ports, which may extend through holes (not shown) in the housing 10 (these holes may be sealed by the optical fibers, the input/output ports, gaskets, seals, or the like, or combinations thereof). Each of the locations 11 and 12 may include another optical component (e.g., another individual component free-space optics), an output port, or some other optical devices to receive the laser beam 5, depending on various applications.

FIG. 2A-B illustrate a schematic diagram of another magnetically-actuated laser beam control assembly 201 coupled to an optic housing 210, according to various embodiments. The optic housing 210, the electromagnet 241, the ferroelectric or ferromagnetic material 231, and the circuitry 223 may be similar in any respect to any optic housing, electromagnet, ferroelectric or ferromagnetic material, or circuitry described herein. The laser beam 205, the locations 212 and 211 (FIG. 2B), and the optical component 232 may be similar in any respect to any laser beams, locations, or optical components described herein.

A planar magnetically permeable cover 215 is coupled to an opening in the optic housing 210. In this example, no flanges are illustrated, but flanges similar in any respect to those described already may be used with a planar cover such as cover 215. In other examples, it may be possible to affix the cover 215 to the opening in the optic housing 210 using a pressure fit, adhesives, tape, or the like, or combinations thereof. The cover 215 may be formed from the same material as the cover 15 (FIG. 1).

A flexure 245 may have sections similar in any respect to the sections of the linkage 45 (FIG. 1). However, the flexure 245 may also include a deformable section 246 that may deform when the electromagnet 241 is energized (this is shown in FIG. 2B where the deformable section 246 is compressed). Referring again to FIG. 2A, the deformable section 246 may urge the ferroelectric or ferromagnetic material 231 into a non-compressed state when the electromagnet 241 is de-energized.

In this embodiment, a stopping device 242 may be coupled to or integrally formed on an interior of the optic housing 210. The stopping device 242 may be formed of any material. The stopping device 242 may limit the range of motion of the optic component 232 similar in any respect to any stopping device described herein.

In this embodiment, the optical component 232 is coupled to the flexure 245 using an adjustable optic mount 237. The adjustable optic mount 237 may have a lower section to fasten to the flexure 245 and an upper section arranged for fastening the optical component 232, where the upper section is hingably or pivotally movable with respect to the lower section. Once the adjustable reflector mount 237 is adjusted to the correct position, further movement may be restricted. Any embodiment used herein may include any reflector mount, now known or later developed.

Magnetically-Actuated Laser Beam Control Assembly with Position Feedback

Various embodiments may feature position feedback, which may provide physical detectability of whether the optical component is in the expected location or not. Such a feature may be used for diagnostic and/or safety purposes. In one embodiment, a permanent magnet could be included on the optical component or any part of any linkage or flexure described herein. A hall-effect or reed switch may then be used to detect the permanent magnet to derive a position of the optical component or the linkage or flexure (if the permanent magnet is detected, the optical component or linkage may be in one position of the pair of positions, and otherwise the optical component or linkage may be in the other position of the pair of positions). The hall-effect or reed switch may be part of the circuitry of any circuitry described herein.

In another embodiment, any circuitry described herein may energize the electromagnet (e.g., electromagnetic coil) using a pulsed signal, and then may detect change in inductance of the electromagnet (e.g., electromagnetic coil) during a time period between energizing pulses. Such an embodiment uses the electromagnet (e.g., electromagnetic coil) to drive movement during the pulses, but uses the electromagnet (e.g., electromagnetic coil) as a sensor between the pulses.

FIG. 3 illustrates a schematic of a magnetically-actuated laser beam control assembly 301 with position feedback, according to various embodiments. The cover 315 may be similar in any respect to any cover described herein. The linkage 345, the optical component 332, and the ferroelectric or ferromagnetic material 331 may be similar in any respect to any linkage, optical component, and ferroelectric or ferromagnetic material described herein. The urging mechanism (e.g., permanent magnet 342) may be similar in any respect to any urging mechanism described herein. The electromagnet 341 may be similar in any respect to any electromagnetic described herein.

The circuitry 323 may perform a similar function as any circuitry described herein. In addition, the circuitry 323 may output a pulsed energization signal 391, which may include a non-actuating cut off period. The non-actuating cut off period may have a duration selected to be short enough so as to not result in any movement of the linkage 345. In the non-actuating cut off period, the circuitry 323 may sense 392 an inductance of the coil of the electromagnet 341 (e.g., over the same wire). If the inductance is at least equal to a predefined threshold, the circuitry 323 may determine that the ferroelectric or ferromagnetic material 331 is positioned as shown in solid lines. If the inductance is less than the threshold, the circuitry 323 may determine that the ferroelectric or ferromagnetic material 331 is not positioned as shown (which indicates that the optical component 332 is not in the expected position) This may be logged by the circuitry 232. The circuitry 323 may enter an exception process in the case of inferring that the optical component 232 is not in the expected position (e.g., may send an alarm to a person, may power down the laser system, etc.)

This embodiment also includes adjustable stopping devices 361 and 362. In various embodiments, these devices 361 and 362 may be threaded and rotatable to drive in or out of the cover 315. A person may manually tune the limits of movement of the linkage 345 using information provided by the circuitry 323 from a sensing cycle. In various embodiments, a gasket or seal may be used in combination with the devices 361 and 362 to prevent contamination through the threaded hole (and these gaskets/seals may have a long lifespan given that the devices 361 and 362 may be moved infrequently—much less frequently than a shaft in mechanically-actuated laser beam control assemblies).

Referring again to FIG. 1, the circuitry 23 (or any other circuitry described herein) may be implemented using application-specific hardware or general purpose hardware to execute instructions (e.g., hardware such as a general purpose processor and associated software). We use the term software herein in its commonly understood sense to refer to programs or routines (subroutines, objects, plug-ins, etc.), as well as data, usable by a machine or processor. As is well known, computer programs generally comprise instructions that are stored in machine-readable or computer-readable storage media. Some embodiments of the present invention may include executable programs or instructions that are stored in machine-readable or computer-readable storage media, such as a digital memory. We do not imply that a “computer” in the conventional sense is required in any particular embodiment. For example, various processors, embedded or otherwise, may be used in equipment such as the components described herein.

Memory for storing software again is well known. In some embodiments, memory associated with a given processor may be stored in the same physical device as the processor (“on-board” memory); for example, RAM or FLASH memory disposed within an integrated circuit microprocessor or the like. In other examples, the memory comprises an independent device, such as an external disk drive, storage array, or portable FLASH key fob. In such cases, the memory becomes “associated” with the digital processor when the two are operatively coupled together, or in communication with each other, for example by an I/O port, network connection, etc. such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such as a conventional rotating disk drive. All such memories are “machine readable” or “computer-readable” and may be used to store executable instructions for implementing the functions described herein.

A “software product” refers to a memory device in which a series of executable instructions are stored in a machine-readable form so that a suitable machine or processor, with appropriate access to the software product, can execute the instructions to carry out a process implemented by the instructions. Software products are sometimes used to distribute software. Any type of machine-readable memory, including without limitation those summarized above, may be used to make a software product. That said, it is also known that software can be distributed via electronic transmission (“download”), in which case there typically will be a corresponding software product at the transmitting end of the transmission, or the receiving end, or both.

In view of the many possible embodiments to which the principles of the disclosed technology may be applied, it should be recognized that the illustrated embodiments are only preferred examples and should not be taken as limiting the scope of the disclosure. We claim as our invention all that comes within the scope and spirit of the appended claims.

1. An apparatus, comprising:
an optics housing providing an environmentally isolated optics cavity; and
a magnetically-actuated laser beam control assembly having a first sub-assembly located inside the environmentally isolated optics cavity and further having a second sub-assembly located outside the environmentally isolated optics cavity,
wherein the first sub-assembly that is located inside the environmentally isolated optics cavity includes a linkage having a first section and a second section;
an optical component on the first section of the linkage; and
a ferroelectric or ferromagnetic material on the second different section of the linkage;
wherein the second sub-assembly that is located outside the environmentally isolated optics cavity includes an electromagnet energizable to impart a magnetic force to the ferroelectric or ferromagnetic material to move the optical component from one of a resting position and a different position to the other of the resting position and the different position,
wherein in one of the positions the optical component is located along a path of a laser beam for optically processing the laser beam and in the other of the positions the optical component is not located along the path of the laser beam.

2. The apparatus of claim 1, wherein the optics housing defines an opening, and the apparatus further comprises a magnetically permeable barrier to cover the opening, the magnetically permeable barrier sealingly coupled to the optics housing.

3. The apparatus of claim 2, wherein the magnetically permeable barrier is formed from a plastic material and the optics housing is formed from a different material.

4. The apparatus of claim 2, wherein the magnetically permeable barrier comprises a planar cover.

5. The apparatus of claim 2, wherein the magnetically permeable barrier comprises a non-planar cover.

6. The apparatus of claim 4, wherein the linkage comprises a flexure.

7. The apparatus of claim 6, wherein the first end of the flexure is coupled to part of an inside of the optics housing.

8. The apparatus of claim 7, further comprising a support on a different part of the inside of the optics housing, wherein the linkage rests on the support in the resting position.

9. The apparatus of claim 5, wherein the non-planar cover includes a flange, wherein the flange is sealingly coupled to a part of the optics housing that defines the opening.

10. The apparatus of claim 5, wherein the non-planar cover forms a projection on the optics housing when sealingly coupled to the optics housing, wherein an interior of the projection defines an aperture, wherein the second section of the linkage is located in the aperture and the first section of the linkage is located outside the cavity defined by the aperture.

11. The apparatus of claim 1, wherein the optical component comprises a light-reflecting optical component or a light-refracting optical component.

12. The apparatus of claim 1, wherein the optical component comprises a reflector.

13. The apparatus of claim 12, wherein the reflector comprises a partial reflector.

14. The apparatus of claim 1, further comprising an adjustable mount on the first section of the linkage, wherein the optics component is coupled to the linkage using the adjustable mount, wherein the adjustable mount includes:
a lower section to attach to the first section of the linkage; and
an upper section hingably or pivotally coupled to the lower section, wherein the optical component is coupled to the upper section.

15. The apparatus of claim 1, wherein the electromagnet comprises a solenoid, and wherein the further comprising a circuitry configured to operate the solenoid as a sensor by detecting changes in inductance of the solenoid, wherein the circuitry identifies the presence or absence of a magnetic field proximate to the coil to identify a current position of the optical component.

16. A magnetically-actuated laser beam control assembly, comprising:
a magnetically permeable cover arranged to sealingly couple to an optics housing to cover an opening of the optics housing; and
a first sub-assembly on a first side of the magnetically permeable cover, and a second sub-assembly on a second different side of the magnetically permeable cover;
wherein the first sub-assembly located on the first side of the magnetically permeable cover includes a linkage having a first section and a second section;
the first section of the linkage to receive an optical component; and
a ferroelectric or ferromagnetic material on the second section of the linkage;
wherein the second sub-assembly that is located outside the optics housing includes an electromagnet energizable to impart a magnetic force to the ferroelectric or ferromagnetic material to move the optical component from one of a resting position and a different position to the other of the resting position and the different position,
wherein in one of the positions the optical component is located along a path of a laser beam for optically processing the laser beam and in the other of the positions the optical component is not located along the path of the laser beam.

17. The magnetically-actuated laser beam control assembly of claim 16, further comprising one or more adjustable stopping devices to adjustably limit a range of travel of the linkage.

18. The magnetically-actuated laser beam control assembly of claim 16, further comprising means for urging the linkage into the resting position.

19. The magnetically-actuated laser beam control assembly of claim 16, wherein the urging means comprises a permanent magnet.

20. The magnetically-actuated laser beam control assembly of claim 16, wherein the ferroelectric or ferromagnetic material includes a permanent magnet and the urging means comprises circuitry to reverse a polarity of the electromagnet.
